(19) United States
(12) Patent Application Publication
(10) Pub. No.: US 2007/0151983 A1
(43) Pub. Date: Jul. 5, 2007

(54) Fuel cartridge with a flexible bladder for storing and delivering a vaporizable liquid fuel stream to a fuel cell system

(76) Inventors: Nimesh Patel, Surrey (CA); Kevin Marchand, Burnary (CA)

Correspondence Address: MCANDREWS HELD & MALLOY, LTD, 500 WEST MADISON STREET, SUITE 3400, CHICAGO, IL, 60661, US

(21) Appl. No.: 11/340,077

(22) Filed: Jan. 25, 2006

Related U.S. Application Data
(60) Provisional application No. 60/755,182, filed on Dec. 30, 2005.

(51) Int. Cl. B65D 35/28; B67D 5/64; B65D 30/10

(52) U.S. Cl. 222/95; 222/160; 220/9.1

(57) ABSTRACT

A fuel cartridge stores and delivers a vaporizable liquid fuel stream to one or more fuel cells. The cartridge includes a housing with an interior cavity, a fuel stream port with a bidirectional flow valve, a pressure relief valve for discharging a gas stream at a set pressure, a bladder located within the interior cavity and formed from a liquid-impermeable and gas-permeable liner, and a compression mechanism for imparting positive pressure to the bladder. In a fuel storage mode, the compression mechanism induces flow of vaporous fuel through the bladder liner. When the fuel cell fuel stream inlet pressure is less than the bladder pressure, the bladder discharges a liquid fuel stream in a fuel delivery mode. When the fuel cell fuel stream inlet pressure is greater than the bladder pressure, the fuel cell outlet fuel stream is returned to the bladder in a fuel return mode.

### CROSS-REFERENCE TO RELATED APPLICATION(S)

This application is related to and claims priority benefits from U.S. Provisional Patent Application No. 60/755,182 filed Dec. 30, 2005, entitled “Fuel Cartridge With A Flexible Bladder For Storing And Delivering A Vaporizable Liquid Fuel Stream To A Fuel Cell System”. The '182 provisional application is hereby incorporated by reference herein in its entirety.

### FIELD OF THE INVENTION

The present invention relates generally to fuel storage containers for fuel cells, such as direct liquid fuel cells, generally having flexible inner containers. More particularly the invention relates to fuel storage containers suitable for use with portable fuel cell applications.

### BACKGROUND OF THE INVENTION

Fuel cells are electrochemical cells in which a free energy change resulting from a fuel oxidation reaction is converted into electrical energy. Organic fuel cells are a useful alternative in many applications to hydrogen fuel cells, overcoming the difficulties of storing and handling hydrogen gas. In an organic fuel cell, an organic fuel such as methanol is oxidized to carbon dioxide at an anode, while air or oxygen is simultaneously reduced to water at a cathode. Organic/air fuel cells have the advantage of operating with a liquid organic fuel. Although methanol and other alcohols are typical fuels of choice for direct fuel cells, recent advances presented in U.S. Patent Application Publication Nos. 2003/0198852 and 2004/0114418 disclose formic acid fuel cells with high power densities and current output. Exemplary power densities of 15 mW/cm² and much higher were achieved at low operating temperatures, and provided for compact fuel cells.

Mobile devices and other low power end-uses require replacement power modules in a small space, for example cell handsets require on the order of 3 watts in a cavity of 10 cc to 30 cc. Thus it is desirable for the fuel cell to operate at high power density and the stored fuel to have a high latent power density. In particular to store a high concentration of the consumed fuel is desirable. For formic acid fuel, storing highly concentrated solutions presents problems of evaporation gas management during both storage and operating temperature ranges, and typically low concentrations are employed, limiting stored energy density.

There are a range of solutions to the problems of providing a fuel storage cartridge for delivering fuel to a fuel cell in a low power range suitable for mobile end-uses. These solutions have typically been designed for methanol-based fuel, which in comparison to a liquid fuel such as formic acid fuel, has no requirements for out gassing relief of evaporating vapors.

Typically cartridges include a housing, a fuel bladder or liner in the housing and a fuel port coupled to the bladder for refueling and fueling. There is a common problem of how to most effectively and efficiently extract or deliver fuel from the cartridge to the fuel cell system while reducing overall system complexity and avoiding additional problems, and increasing effective stored energy density by reducing additional space taken up by the cartridge.

Known solutions belong to the following groups, movable springs, expandable bladders, external or internal powered fuel pumps, wicking fuel ports, and interaction of multiple cavities or bladders.

The most common form of active pumped cartridge employs a movable spring, spring biased plate or wall to push on the liner or bladder and continue to provide pressure as the volume of fuel decreases in the bladder. For example, U.S. Patent Application Publication Nos. 2003/0129464 and 2004/0072049 describe spring and plate mechanisms. U.S. Pat. No. 6,924,054 and PCT/International Publication No. WO 03/043112 describe movable barriers with a spring. Cartridges employing mechanical springs again restrict the space utilization and stored energy density. Further they are mainly suited for end-uses where bladder volume decreases with fuel delivery and a compressive force is required to maintain fuel pressure.

Expandable bladders are disclosed in U.S. Patent Application Publication Nos. 2004/0013927 and 2002/0197522, along with expandable pressure members that provide a positive pressure on the bladder. The expandable bladder disclosed is impermeable to the methanol fuel. An example of the pressure member is compressible foam butted against the bladder. Limitations of this design are (a) that the extra space of the compressible foam limits stored energy density (as illustrated, the volume of the bladder and foam are approximately equal), and (b) that the design is unsuitable for formic acid fuel as the fuel vapor is not managed or relieved.

Actively pumping the fuel out of the cartridge is commonly done, but requires extra components. Pumps can be employed to pump gas back into the cartridge to pressurize the bladder as described in U.S. Patent Application Publication No. 2005/0058858 in which air is pumped back into the cartridge cavity through a second port for maintaining pressure as the bladder volume decreases. Relying only on fuel pumps reduces overall system energy efficiency due to the extra power drain.

A common design for passive fuel delivery is providing wicks coupled between the liner and the fuel inlet, acting by capillary action to transfer fuel. U.S. Pat. No. 6,726,470 and U.S. Patent Application Publication No. 2004/0126643 are representative of wick fuel delivery. Problems with wicking systems include material incompatibility with formic acid fuel, and suitable control of fuel delivery rate.

Multiple cavities or bladders can be employed for pressure management and containing waste fuel. For example, U.S. Patent Application Publication No. 2003/0082427 describes a dual bladder cartridge with one of the bladders having an internal biased spring to pressurize the primary fuel bladder, and two ports for delivering fuel and receiving waste products. The cartridge is additionally complex and costly due to the extra components and less than optimal for storage energy density.

Due to the hazardous nature of formic acid, it is a requirement that not more than very low levels of formic acid or vapors are released from the cartridge, known hot swappable liquid fuel cartridges are primarily designed for methanol fuel not formic acid. In particular, there is a no solution for a cartridge for formic acid that can supply fuel or be coupled or released over a wide range of orientations, without adverse emissions or change in operations.

An additional problem arises from mobile device end-uses where there is restricted space for both the fuel cell system and the cartridge, and the necessity for efficient venting of the fuel cell system and cartridge independently from the mobile device housing.

There is thus a need for a fuel cartridge that is well-suited to vaporizable liquid fuels such as formic acid, that has a design for pressurizing and delivering vaporizable liquid fuel without powered or movable components, and that is suitable for safely storing formic acid, having a single cavity enclosure for high energy density, recycles depleted fuel from the fuel cell system, and meets safe emissions, and enables an associated fuel cell system to operate with limited movable parts.

### SUMMARY OF THE INVENTION

A fuel cartridge stores and delivers a vaporizable liquid fuel stream to an electric power generation system that includes one or more fuel cells interposed between a fuel stream inlet and a fuel stream outlet. The fuel cartridge comprises:
(a) a cartridge housing having an interior cavity and an exteriorly facing coupling surface
(b) a fuel stream port encompassed by the coupling surface and having a sealable valve accommodating bidirectional flow of the liquid fuel stream;
(c) a pressure relief valve for discharging a gaseous stream from the cartridge housing at a set pressure;
(d) a bladder comprising a substantially liquid-impermeable and gas-permeable liner, the bladder disposed within the interior cavity and capable of storing, delivering and receiving a quantity of the liquid fuel; and
(e) a compression mechanism for imparting at least a minimal positive fluid pressure to the bladder.
   In operation:
(i) in a fuel storage mode, the compression mechanism induces flow of vaporous fuel through the bladder liner, thereby increasing pressure within the cartridge interior cavity to a magnitude no greater than the set pressure;
(ii) when the fuel cell fuel stream inlet pressure is less than the bladder pressure, a liquid fuel stream is discharged from the bladder in a fuel delivery mode; and
(iii) when the fuel cell fuel stream inlet pressure is greater than the bladder pressure, the fuel cell outlet fuel stream is returned to the bladder in a fuel return mode.

In a preferred embodiment, the foregoing fuel cartridge further comprises:
(e) an interface cover sealingly coupled to the housing coupling surface and encasing the relief valve, the interface cover comprising:
   a first opening formed therein in fluid communication with the fuel stream port,
   a second opening formed therein in fluid communication with the fuel cell fuel stream outlet, and
   a third opening formed therein for discharging a fuel cartridge exhaust stream.

In a preferred embodiment, the interface cover further comprises:
a substantially fluid-impermeable seal circumscribing each of the fuel stream port and the second opening; and
a gaseous stream filter interposed between the pressure relief valve and the second opening, such that at least one of the discharged gaseous stream and the fuel cell outlet fuel stream is passed through the filter to trap contaminants present in the at least one of the discharged gaseous stream and the fuel cell outlet fuel stream.

In one embodiment of the foregoing fuel cartridge, the contaminants comprise carbon monoxide and vaporous formic acid. The compression mechanism preferably comprises at least one spring interposed between the bladder and the cartridge housing. Alternatively, or in addition, the compression mechanism can include at least one fluid-filled piston and/or at least one elastomeric member, preferably a plurality of elastomeric members circumscribing the bladder exterior.

In a preferred embodiment of the foregoing fuel cartridge, the gaseous stream filter is configured to sealingly encase the third opening, and wherein the vaporizable liquid fuel stream is discharged through the pressure relief valve, directed through the gas filter, and exhausted through the third opening.

In one embodiment, the vaporizable liquid fuel is organic, more preferably formic acid, more preferably an aqueous formic acid solution having a concentration between 10-90% by weight formic acid, yet more preferably an aqueous formic acid solution has a concentration between 50-90% by weight formic acid, and even more preferably having a concentration between 70-90% by weight formic acid.

In a preferred embodiment of the foregoing fuel cartridge, the bladder further comprises a pair of compression plates disposed on opposing sides of the bladder, the compression plates operatively associated with the compression mechanism for distributively imparting pressure to the bladder. The bladder filled volume is preferably less than about 90% of the interior cavity volume. The bladder is preferably formed from a flexible sheet material.

In a preferred embodiment of the foregoing fuel cartridge, the coupling surface encompasses the fuel stream port and the pressure relief valve.

In a preferred embodiment of the foregoing fuel cartridge, the gaseous stream filter traps contaminants in one of the discharged gaseous stream and the fuel cell outlet fuel stream, and a second gaseous stream filter traps contaminants in the other of the discharged gaseous stream and the fuel cell outlet fuel stream.

In a preferred embodiment of the foregoing fuel cartridge, the interface cover is configured such that the cartridge housing is capable of being press-fitted into a receptacle formed in the system housing such that the first opening is sealingly couplable to a corresponding first opening formed in the system housing receptacle, the corresponding first opening in fluid communication with the fuel cell fuel stream inlet, and such that the second opening is sealingly couplable to a corresponding second opening formed in the system housing receptacle, the corresponding second opening in fluid communication with the fuel cell fuel stream outlet. At least a portion of the cartridge housing is preferably deformable such that the cartridge housing is capable of substantially filling the system housing receptacle and maintaining sufficient rigidity to establish a seal between the system housing receptacle and the interface cover.

In a preferred embodiment of the foregoing fuel cartridge, the cartridge housing and the interface cover are secured to restrict access to the bladder. The fuel cartridge the bladder is preferably formed from a material that inhibits condensation of liquid fuel on regions of the liquid-impermeable liner not in contact with the liquid fuel. The sealable valve is preferably a spring-loaded slidable valve capable of coupling to a cooperating valve on the system housing. The slidable valve preferably has a bayonet-type configuration.

In a preferred embodiment of the foregoing fuel cartridge, the fuel cartridge discharged gaseous stream contaminant concentration is no greater than about 5 parts per million by weight. The bladder fluid pressure is preferably sufficient in the fuel storage mode to permit disconnection of the cartridge from the system housing and reconnection of a fresh cartridge to the system housing without substantial deterioration of fuel cell electrical performance. The cartridge is preferably orientation-independent, such that the fuel storage, fuel delivery and fuel return modes are operable without regard to gravity.

In a preferred embodiment of the foregoing fuel cartridge, the interface cover, the sealable valve and the pressure relief valve are configured to inhibit fuel leakage during disconnection of the cartridge from the system housing and reconnection of a fresh cartridge to the system housing. The cartridge is capable of operation in the fuel storage, fuel delivery and fuel return modes following an orientation-independent drop test from 1.5 meters. The cartridge is preferably capable of operation in the fuel storage, fuel delivery and fuel return modes following storage at a temperature in the range of −40° C. to +70° C. The fuel stream port preferably has a fuel feed tube extending therefrom into the bladder interior volume, whereby, in the fuel delivery mode, the fuel stream is drawn from a substantially blended fuel zone.

In a preferred embodiment, a bladder stores and expresses a vaporizable liquid fuel stream. The bladder comprises:
(a) an inner liner permeable to the liquid fuel, the inner liner having an inwardly-facing surface defining an interior volume for containing the vaporizable liquid fuel and an outwardly-facing surface:
(b) an outer liner substantially impermeable to the liquid fuel, the outer liner having an inwardly-facing surface and an outwardly-facing surface contacting an exterior volume; (c) a spacer interposed between the inner liner and the outer liner for maintaining a spaced relationship between the inner liner and the outer liner, thereby defining a lumen; and
(d) a passageway fluidly interconnecting the lumen and the exterior volume.
   The inner liner, the outer liner and the spacer form a three-layer laminate

In one embodiment of the foregoing bladder, the vaporizable liquid fuel is organic and preferably comprises formic acid.

In a preferred embodiment of the foregoing bladder, at least one gas-permeable seam is formed at a junction of opposing inner liner edge portions, whereby the lumen fluidly communicates with the interior volume via the at least one gas-permeable seam to conduct vaporous fuel from the lumen to the exterior volume. The outer liner preferably has a plurality of microperforations formed therein, whereby the lumen fluidly communicates with the interior volume via the plurality of microperforations to conduct vaporous fuel from the lumen to the exterior volume. At least one gas-permeable seam is preferably formed at a junction of opposing inner liner edge portions, whereby the lumen fluidly communicates with the interior volume via the at least one gas-permeable seam to further conduct vaporous fuel from the lumen to the exterior volume.

In a preferred embodiment of the foregoing bladder, the inner liner comprises expanded polytetrafluoroethylene and the outer liner comprises polytetrafluoroethylene, more preferably expanded polytetrafluoroethylene. The bladder preferably remains capable of storing and expressing the vaporizable liquid fuel stream following storage at a temperature in the range of −40° C. to +70° C. The bladder preferably remains capable of storing and expressing the vaporizable liquid fuel stream following imposition of 100 kilograms crushing force of on all sides of the bladder. The bladder preferably remains capable of storing and expressing the vaporizable liquid fuel stream following an orientation-independent drop test from 1.5 meters. The bladder preferably remains capable of storing and expressing the vaporizable liquid fuel stream following vibration up to 8G.

In a preferred embodiment of the foregoing bladder, fuel condensation is inhibited at the inner liner outwardly-facing surface when the outer liner outwardly-facing surface contacts an exterior volume having a temperature lower than the lumen temperature.

In a preferred embodiment of the foregoing bladder, the spacer can be formed as a mesh. The spacer can also comprise a plurality of discrete spacer elements, preferably arranged in a grid or arranged randomly.

In a preferred embodiment of the foregoing bladder, the laminate is consolidated by hot-press bonding. The inner liner and the outer liner are preferably formed from a flexible sheet material.

In another embodiment, a bladder for storing and expressing a vaporizable liquid fuel stream comprises:
(a) an inner liner permeable to the liquid fuel, the inner liner having an inwardly-facing surface defining an interior volume for containing the vaporizable liquid fuel and an outwardly-facing surface;
(b) an outer liner substantially impermeable to the liquid fuel, the outer liner having an inwardly-facing surface and an outwardly-facing surface contacting an exterior volume; and
(c) a passageway fluidly interconnecting the lumen and the exterior volume.
   At least one of the inner liner and the outer liner has a plurality of integral spacers extending therefrom in the direction of the other of the inner layer and the outer layer, thereby defining a lumen, and wherein the inner liner and the outer liner form a two-layer laminate.

In a preferred embodiment of the foregoing bladder, the vaporizable liquid fuel is organic and preferably comprises formic acid.

In a preferred embodiment of the foregoing bladder, at least one gas-permeable seam is formed at a junction of opposing inner liner edge portions, whereby the lumen fluidly communicates with the interior volume via the at least one gas-permeable seam to conduct vaporous fuel from the lumen to the exterior volume. The outer liner preferably has a plurality of microperforations formed therein, whereby the lumen fluidly communicates with the interior volume via the plurality of microperforations to conduct vaporous fuel from the lumen to the exterior volume. At least one gas-permeable seam is formed at a junction of opposing inner liner edge portions, whereby the lumen fluidly communicates with the interior volume via the at least one gas-permeable seam to further conduct vaporous fuel from the lumen to the exterior volume.

### BRIEF DESCRIPTION OF THE DRAWINGS

FIGS. 1A and 1B are exploded perspective and cross-sectional views, respectively, of an embodiment of the present fuel cartridge containing a flexible bladder for storing and delivering a vaporizable liquid fuel.

FIGS. 2A and 2B are cross-sectional and perspective views, respectively, of an embodiment of the flexible bladder in which the permeable liner structure facilitates gas transfer along a seam formed at the perimeter of the liner.

FIGS. 3A and 3B are exploded perspective and perspective views, respectively, of another embodiment of the flexible bladder in which a permeable liner structure facilitates gas transfer at the perimeter seam.

FIGS. 4A, 4B and 4C are exploded perspective, cross-sectional and perspective views, respectively, of another embodiment of the flexible bladder having a permeable liner structure.

FIGS. 5A, 5B and 5C are exploded perspective, cross-sectional and perspective views, respectively, of another embodiment of the flexible bladder having a permeable liner structure, openings formed in the outer liner, and a sealed perimeter.

FIG. 6 is a perspective view of a flexible bladder having a permeable liner structure with elastomeric members associated therewith for imparting positive fluid pressure to the bladder.

FIG. 7 is a cross-sectional view of a fuel cartridge with a flexible bladder, illustrating the relative locations of the pressure relief valve, gaseous stream filter and fuel stream port.

FIGS. 8A, 8B, 8C and 8D are perspective, end, side cross-sectional and front cross-sectional views, respectively, of a fuel cartridge with flexible bladder coupled to fuel cell system ports, as well as gaseous stream management components.

FIG. 9 is a front cross-sectional view of a fuel cartridge with flexible bladder undergoing a change in orientation during a vertical drop from a position 45° from vertical to position 135° from vertical.

FIG. 10 is a front cross-sectional view of a dual-port fuel cartridge with flexible bladder, illustrating the connection of separate fuel stream inlet and outlet ports in the cartridge to corresponding fuel cell system ports.

FIGS. 11A and 11B are front cross-sectional views of a fuel cartridge with flexible bladder and needle port coupling to accommodate a fueling needle from a fuel cell system in an uncoupled position (FIG. 11A) and a coupled position (FIG. 11B).

FIG. 12 is a front cross-sectional view of a fuel cartridge with flexible bladder and an additional exhaust cavity with a flexible bladder contained therein for receiving an exhaust gas stream from a pressure relief valve.

FIGS. 13A, 13B, 13C and 13D are perspective views of embodiments of fuel cartridges capable of coupling with and delivering a fuel stream to a fuel cell system, in which the cartridge embodiments have a front end port (FIG. 13A), a side filter cavity (FIG. 13B), a raised coupling section (FIG. 13C), and a top-mounted port (FIG. 13D).

FIGS. 14A, 14B and 14C are perspective and exploded perspective views illustrating a method of replacing a flexible bladder in a fuel cartridge by first removing the used bladder (FIG. 14A), then attaching a new bladder to the cartridge fuel stream port (FIG. 14B), and then filling the new bladder in the assembled cartridge with fuel from a fueling station.

### DETAILED DESCRIPTION OF PREFERRED EMBODIMENT(S)

Fuel cartridges are preferred to supply fuel to fuel cell systems, particularly for mobile miniature fuel cell end-uses where the fuel cell is operating with a direct liquid organic fuel such as methanol or formic acid. Fuel cartridges have been invented that solve the problems of storing evaporating fuel, delivering fuel with no moving active components, and managing fuel cell system byproducts efficiently and safely. A fuel cartridge typically has in its most basic form, a bladder, a fuel port coupled to the bladder, and apparatus for extracting the fuel from the cartridge to the fuel cell system. The use of low flashpoint organic fuels in direct fuel cell systems, such as formic acid, create unusual requirements on fuel cartridge design and materials. These include how to manage evaporating gas and vapor from the stored fuel, while providing fuel delivery to the associated fuel cell system with minimum moving parts, while increasing energy density of the storage spacer.

The properties of formic acid include: (a) irreversible evaporation and decomposition into carbon monoxide (CO) and water, thereby resulting in a reduction in fuel concentration; (b) consumability over a wide range of temperatures, thereby enabling direct formic acid fuel cells to operate at room temperature with no preheating; and (c) leak-detection additives are not required, as leaks can be detected by formic acid's odor.

The present bladder embodiments are permeable to formic acid vapor byproducts primarily CO gas and water, which are hereinafter referred to as formic acid vapor, and impermeable to liquid (aqueous) formic acid. It is preferred that the bladder eliminate evaporated vapor products such that primarily usable liquid fuel is delivered for fuel cell operation without gas or water dilution. The term bladder as employed herein, can be equivalently called liner, pouch, sack, sleeve or bag. The present bladder and cartridge design concepts are applicable to vaporizable liquid organic fuels generally, such as methanol or other carbon based liquid fuels; hence, where formic acid is employed within the examples, these other fuels can be equivalently substituted unless specific limitations are described, with appropriate compensation for property differences. Specifically, methanol has a lower flash point than formic acid.

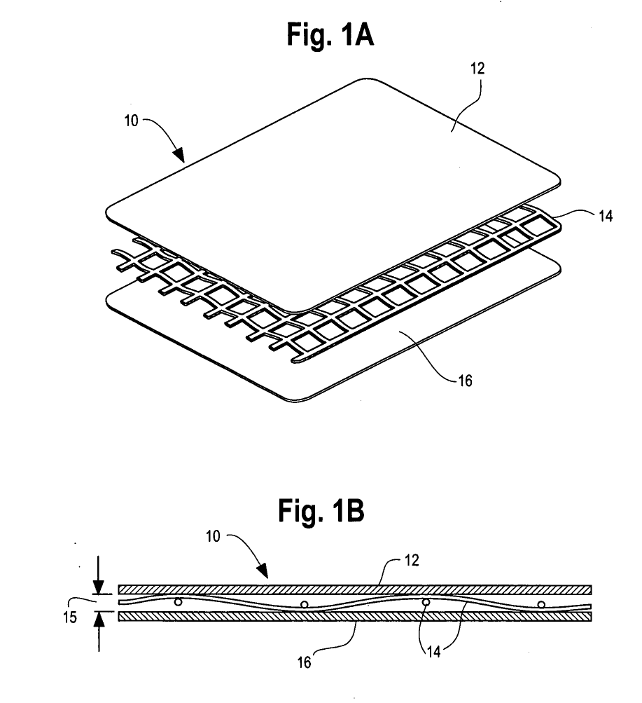

FIGS. 1A and 1B illustrate a laminate structure 10 of an embodiment of a bladder material. An outer liner 12 is impermeable to both formic acid vapor and formic acid liquid, and is intended to be the outside surface of a bladder formed from the laminate structure 10. Liner 12 can be polytetrafluoroethylene (PTFE) material, formed and treated to be impermeable as described. An inner liner 16 is permeable to formic acid vapor and impermeable to formic acid liquid and water. The inner liner 16 can be a modified PTFE material, with surface treated to allow formic acid vapor to transfer through and is preferably expanded PTFE (ePTFE; commonly available under the trade name Gore-Tex®). A separating layer 14 is positioned between the inner and outer liners for the purpose of permitting gas diffusion laterally between the layers and for restricting vapor condensation between layers, which would limit gas diffusion, and buildup over time. In the illustrated example, the separating layer includes interwoven fibers of a material that is non-reactive to formic acid, for example, PTFE or polyethylene. The separating layer can alternatively be formed of discrete spacers formed on either inner or outer liner, multiple layers of elongate members, perforated sheet or combinations thereof. Note that separating layer 14 is not necessary to be in a mesh form for added strength, but can be formed as a mesh for ease of manufacturing. When the three layers are formed in a laminate structure as shown in FIG. 1B, the separating layer creates a gap 15. The forming process is preferably free of adhesive; however a laminating adhesive non-reactive with formic acid could be employed provided diffusion gap is maintained. The gap is selected large enough to permit lateral vapor diffusion but below a threshold to inhibit condensate formation. In this embodiment the gap is preferably in the range one to ten thousands of an inch. Above this range, the formic acid can condense in the layer and cause blockages. The three-layer laminate described is employed to create a fuel bladder with the desired properties for storing and delivering formic acid fuel.

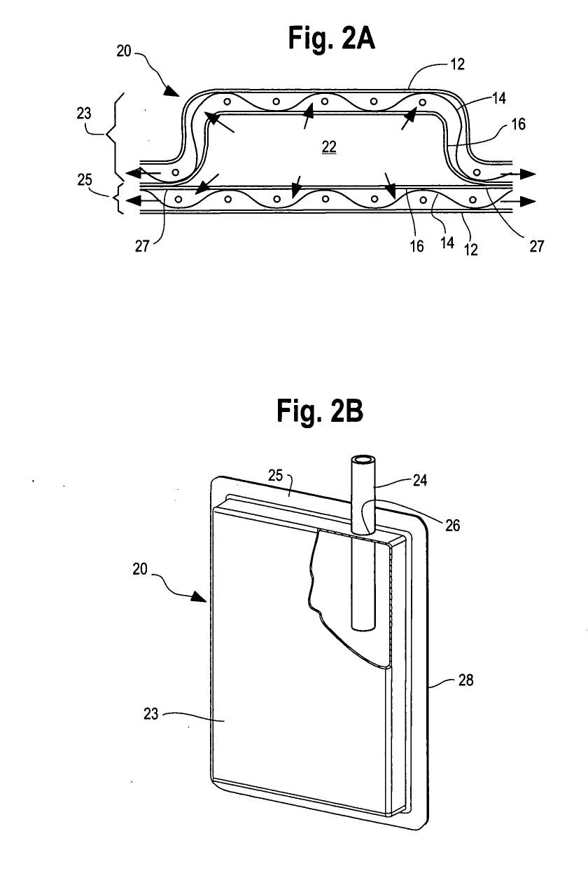

A fuel bladder embodiment employing the previously described laminate is shown in FIGS. 2A and 2B. Although shown formed in a rectangular shaped bladder 20, it will be appreciated that the bladder can be suitably shaped to substantially fill an associated fuel cartridge case. In FIG. 2A, a flat sheet 25 of the previously described laminate is secured to a box shaped sheet of laminate 23, with the inner liner 16 for each sheet facing the enclosed space 22 in which fuel is to be stored. At the perimeter 28, an internal seal 27 is created between the opposing inner liners 16. The seal 27 is preferably created without adhesive, by such processes as localized ultrasonic welding of the inner layers. The laminate should not be deformed at the perimeter; separation gap 15 should be maintained through the seal region so that gas can laterally diffuse from the inside of the sealed pouch to the outside through the gap edges of either sheet 25 or 23. In the perspective view shown in FIG. 2B, a fuel opening 26 is shown and a fuel coupling tube 24 is secured to the fuel opening 26, for example by non-reactive adhesive, sewing the material into the tube, or ultrasonic welding. If the fuel coupling tube is plastic, for example, conventional polymer-securing techniques can be employed, provided they are non-reactive with formic acid. The perspective view shows perimeter 28 through which the evaporated fuel vapor will exit the bladder. It will be appreciated that the bladder could be formed in a wide range of shapes, provided an adequate seal of the nature described is provided. Similarly the fuel opening and tube could be located anywhere on the bladder except the perimeter seal area. The bladder shown in FIGS. 2A and 2B is convenient for fitting into a rectangular enclosure. The bladder and laminate of FIGS. 1A, 1B, 2A and 2B represent an edge-diffusing type of bladder.

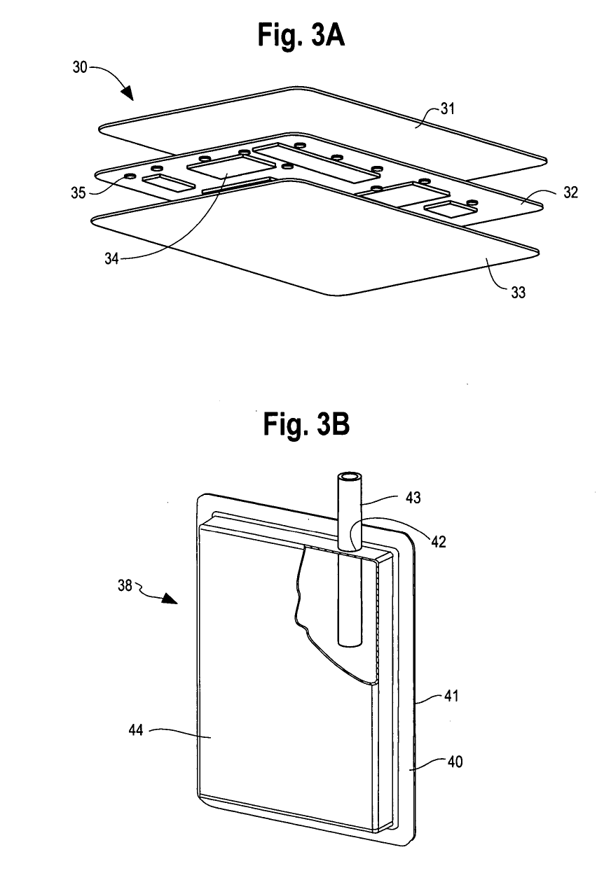

An alternate laminate structure 30 and alternate bladder design 38 is shown in FIGS. 3A and 3B having regions of laminate that are partially separated. To provide a stronger laminate structure it be desirable to distribute contiguous separated regions interspersed with regions of no-separation in which the inner and outer layer are directly laminated to provide extra strength. Outer liner 31 and inner liner 33 are similar to liners 12 and 16. Separator layer 32 has regions 34 with no spacer elements and regions, however; spacer elements 35 are arranged to promote lateral gas transfer along the surface. The resulting laminate has non-separated region 34 in contact with inner liner 33 created indented regions. As previously described, a desirable liner gap is within the restricted range of separation suitable for formic acid vapor transfer. A bladder 38 can be formed from the laminate 30 in a similar manner as the bladder of FIGS. 2A and 2B, as shown in FIG. 3B. Sheet 42 is attached to sheet 40 along sealed perimeter 41, creating a cavity 44. Non-separated regions 39 are also shown. A fuel opening 42 is connected to a fuel coupling tube 43.

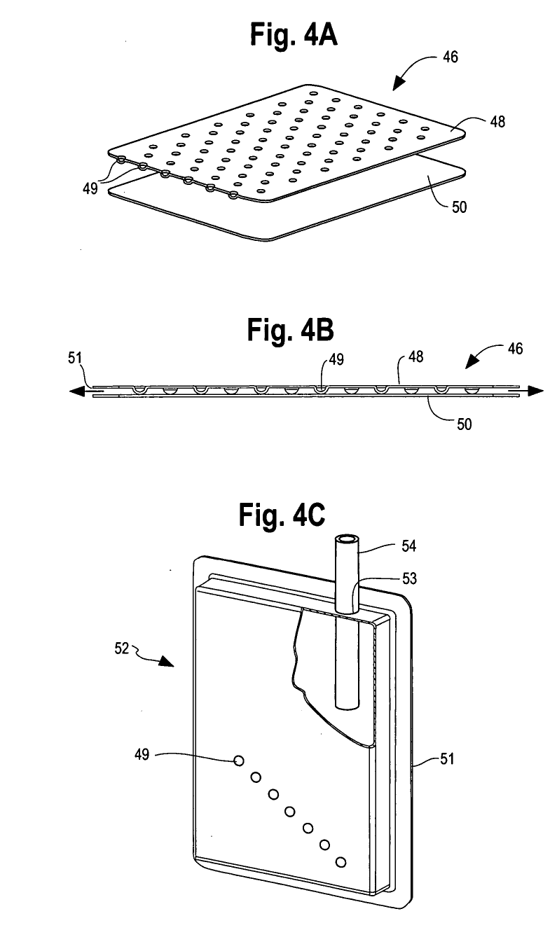

In a simplified version of the bladder liner, the separator material can be replaced by integrated microstructure on one of the inner or outer liners, as shown in FIGS. 4A, 4B and 4C, to form a bladder with only two layers 48 and 50, as specifically illustrated in FIG. 4A. Advances in thermoforming and nanomaterials enable the liners to be processed to create integrated microstructure spacers. Upper liner 48 is formed with microstructured indentations 49, spaced suitably to allow lateral diffusion of formic acid vapor. Inner liner 50 is similar to previous inner liner 16. A cross-sectional view of the two-layer laminate in FIG. 4B shows the space 51 created by microstructures, again preferably less than one 10-thousanth of an inch (0.00254 millimeter). It will be appreciated by persons skilled in the technology involved here that the microstructure can be formed on the inner liner, the outer liner, or both. Sections of the two-layer, permeable laminate are formed into a bladder 52 by securing the inner liners together at perimeter 28, as shown in FIG. 4c, and include a fuel hole 53 and secured fuel transfer tube 54. Fuel transfer tube 54 in this example is shown extending into the bladder, as it could be configured for other bladders illustrated and described herein. Formic acid fuel is contained in the bladder, and formic acid vapor transfers from the inner pouch to inside the laminate layers and laterally diffuses out to the perimeter edges of the bladder to exit the bladder.

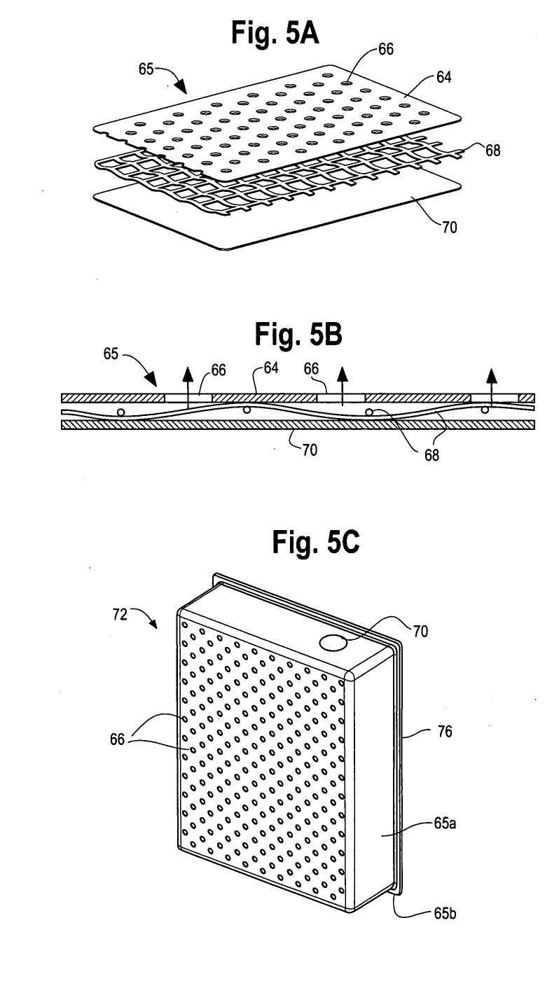

Another version of the membrane can allow partial lateral diffusion with direct transfer through openings in the outer liner, as shown in FIGS. 5A, 5B and 5C. Outer liner 64 has openings 66, such that when laminated with spacer layer 68 and inner liner 70, formic acid vapor enters the gap between inner and outer layers, diffuses laterally and then escapes through one or more of openings 66. The size and spacing of the openings preferably arranged to prevent condensation of liquid fuel vapor and specifically formic acid vapor. Sections of the three-layer permeable laminate are formed into a bladder 72 by sealing the sections of laminate at perimeter 76 such that there is no lateral diffusion through the perimeter, as shown in FIG. 5C, and include a fuel hole and secured fuel transfer tube 74. Formic acid fuel is contained in the bladder, and formic acid vapor transfers from the inner pouch to inside the laminate layers and diffuses out the openings of the bladder outer liner to exit the bladder.

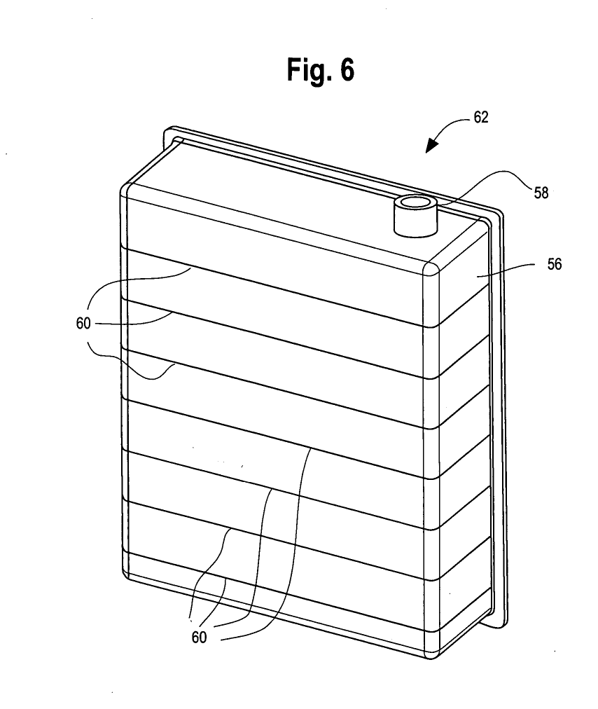

The bladder types described in FIGS. 2A, 2B, 3A, 3B, 4A, 4B, 4C, and 5A, 5B and 5C can include compression elements such as elastic bands that impart a minimum pressure to the contents of the bladder to assist in pushing or expressing formic acid vapor from the bladder, leaving substantially liquid formic acid fuel in the bladder. This minimum pressure is preferably on the order of 1.5 pounds per square inch (71.8 Pascal) or greater. Such a bladder configuration 62 is shown in FIG. 6, which consists of five elastomeric elements 60 in contact with the bladder 56 and stretched to provide at least a minimum internal pressure when the bladder stores fuel. Fuel is expressed from the bladder through fuel hole 58. Persons skilled in the technology involved here will appreciate that the compression elements can be formed of suitable elastomeric materials that are non-reactive to formic acid vapor, such as an elongate rubber strap material, and can be integrated into two or three layers, or positioned outside the outer liner, or can consist of only one compression element. As will be described later, the requirement for the compression elements is to provide a passive pressure of the fuel at low fill levels of at least 0.25 psi (11.97 Pa) and preferably 1.5 psi (71.8 Pa), or during an initial storage phase where the pressure outside the bladder is below 1.5 psi (71.8 Pa).

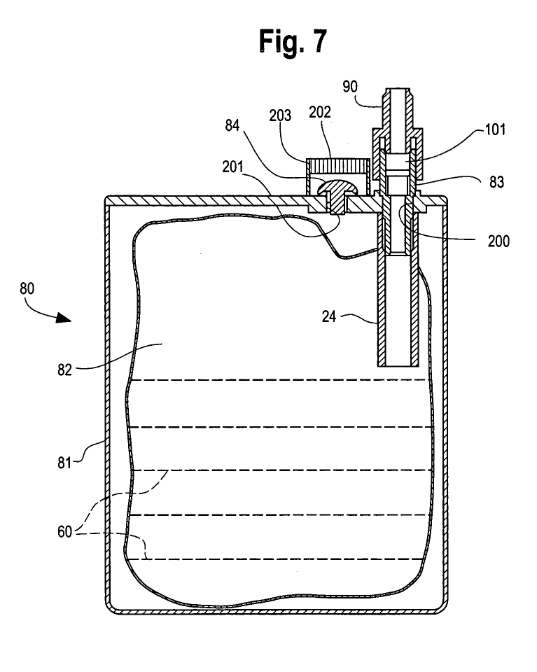

The permeable bladders previously described, can be configured in a cartridge for safe storage of liquid fuel, environmental protection, and orientation independent coupling and operation with an associated fuel cell system. Although the bladder can be employed with a wide range of liquid fuels, there are specific exhaust requirements for formic acid fuel. A basic fuel cartridge 80 is illustrated in cross-section in FIG. 7. Housing 81 is preferably rectangular shaped, as shown, although cartridge shapes having a volume greater than 110% of the filled bladder volume are also suitable for effective operation. The housing is preferably sealed, with sealed joints such as from well known welding methods, and is of a material non-reactive to formic acid, for example stainless steel. A pair of openings 200, 201 is provided on the housing for pressure relief valve exhaust and fuel port access, shown for convenience on one side the housing, but can also be located on housing surfaces suitable for a corresponding cavity (not shown) to which the cartridge is to be fitted. Fuel port 83 is secured and sealed on an opening 200 and connected to a fuel coupling tube 24 attached to the bladder 82. Fuel port 83 is a sealable two-way port, for example, a slidable valve coupling that opens when the cartridge is coupled to a matching port. Bladder 82 does not require securing within the housing, as it typically fills most of the interior space. Pressure relief valve 84 is secured on the other housing opening 201, and is designed to relieve vapor pressure above a set point pressure and has material selected to be non-reactive with formic acid. An optional vapor filter 202 is shown covering the pressure relief valve, and enclosed in housing 203 with vent hole 204. When the liquid fuel is formic acid the vapor filter 202 is required, and a porous carbon filter can be employed that is suitable for removing CO gas. The filter could equivalently be integrated into the pressure relief valve. The pressure relief valve can optionally be substituted with a conventional, commercially-available vacuum release valve or diffusion barrier membrane.

Stored formic acid fuel in the bladder 82 will naturally evaporate and the formic acid vapor exits the bladder walls, increasing the cavity pressure. The relief pressure setting is selected to keep the internal cavity pressure within a preferred range. In typical use, there is preferably no gas released outside the cartridge, however in extended storage conditions the pressure can exceed the relief pressure setting. The cavity pressure forms an integral function of the passive fuel cartridge, as it pressurizes the bladder fuel sufficient to deliver fuel through the port 83 to an associated coupled fuel cell system (not shown). Compression elements 60 are shown on the bladder for additional minimum pressurization of the stored fuel. The fuel cartridge has a desired fuel delivery pressure range as determined by the associated fuel cell design and delivery flow path. In the case of formic acid fuel stored in the illustrated bladder, a preferred example of the maximum of this delivery range is 8 psi (383 Pa), therefore the pressure relief valve opens at approximately 8 psi (383 Pa) pressure to maintain the internal cavity pressure 8 psi (383 Pa) or less. Typically, the pressure maximum in the case of formic acid fuel is 15 psi (718 Pa) or less to reduce risk of explosion. Orientation problems due to mixed gas and liquid within the bladder are solved by the cartridge and bladder combination. The cartridge 80 can be stored or employed in a wide range of orientations, as the intrinsic and extrinsic pressure on the bladder pushes out evaporated gas contained in the bladder, so that primarily liquid fuel remains in the bladder, without a significant gas volume remaining, while uniform liquid fuel pressure for delivery is maintained. Substantially liquid fuel is delivered through the fuel port in an orientation-independent manner, without being interrupted by gas transfer, thereby allowing the associated coupled fuel cell operation to be maintained continuously over a wide range of orientations. In the preferred case, the coupling tube 24 extends inside the bladder approximately halfway to extract a well-mixed quantity of formic acid fuel. A second benefit of the multilayer bladder liner with separation layer, is that the separation layer reduces condensation on the inner liner when stored at low temperatures and for portions of the bladder in proximity to the housing wall, compared to having no separation layer. Condensation is undesirable as it inhibits the gas transfer from inside the bladder. Cartridge 80 of FIG. 7 is a basic example useful for end-uses where the fuel cell product gases are separately exhausted and managed by the fuel cell system.

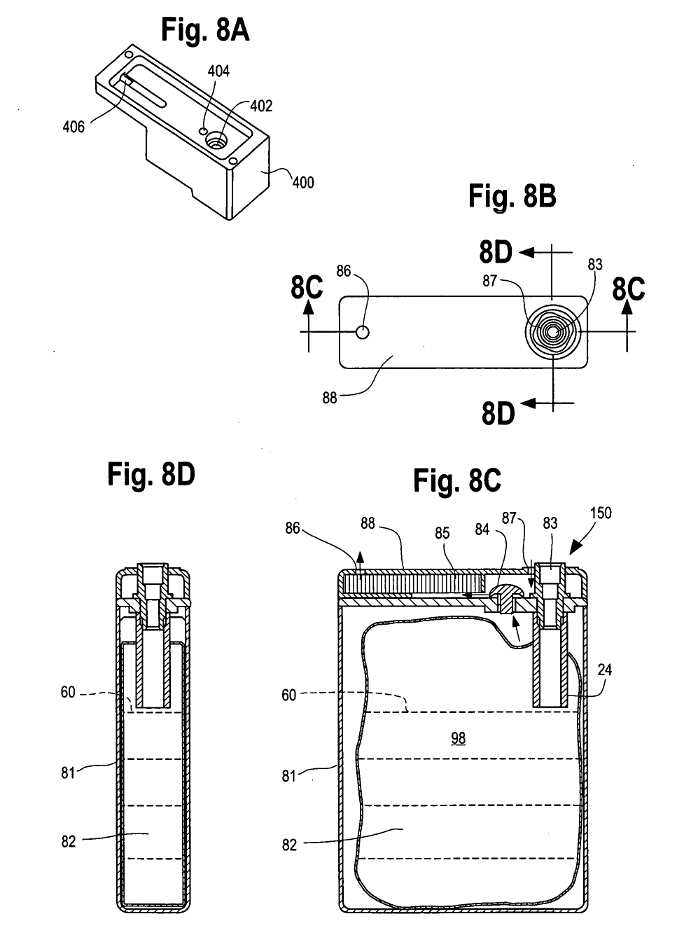

Portable fuel cells are often employed to power mobile devices, and should preferably be small in size and integrated within handheld housings. In the case of cellular telephones, the handheld housing is small and held close to the users head. The cartridge is preferably plugged into the fuel cell ports and hot-swappable. A problem that emerges is how to route and filter both fuel cell product exhaust and cartridge released gases within a confined space. A solution is to process the fuel cell system exhaust at the cartridge. To capture the formic acid vapor exiting the cartridge, a fuel cartridge 150 with integrated exhaust management is shown in FIG. 8B, by adding a port interface cover to the cartridge for routing and filtering exhaust both from the stored fuel and optionally exhaust from the associated fuel cell system. The fuel cartridge 150 has the same two openings and fuel port 83 and relief valve 84. Port interface cover 88 is preferably covering one side of the cartridge housing 81 and preferably planar for coupling to a mating surface to the associated fuel cell system port/manifold 400, but can be split on more than one side or cover a portion of a side or have non-planar portions provided the functions of the interface cover as described herein are still provided. An opening 86 is provided in the outward mating surface of the port interface cover for exhausting byproducts. A second opening is provided as shown in top view, which is larger than fuel port 83 and sufficient to allow exhaust from the fuel cell system to be transferred through the gap around the fuel port 83. This second opening is preferably surrounded by a compression seal perimeter such that when the cartridge is coupled to the associated fuel cell manifold 400 the fuel port is coupled to a corresponding fuel inlet port 402 and the gap surrounding fuel port 83 is coupled to a matching fuel cell exhaust port 404 such that the fuel port coupling is sealed and the fuel cell exhaust port is sealed to the interface cover port. The internal form of the port interface cover 88 is shown in the cross section view. An exhaust filter 85 is tightly fitted within a cavity below the exhaust opening 86, such that exhaust flows through and not around the filter to reach the exhaust opening 86. An internal cavity covers the pressure relief valve 84 and includes the fuel cell exhaust opening surrounding port 83. The internal cavity is connected to the filter and exhaust opening through a small passage gap as illustrated. Stored fuel out gassing escaping the pressure relief valve is forced to traverse the filter and exit with hazardous byproducts such as CO removed. Similarly fuel cell exhaust enters the port interface cover through the gap surrounding fuel port 83 and is forced to traverse the same path through the filter to remove hazardous byproducts such as CO and HCOOH. In the preferred embodiment the port interface cover is secured to the housing 81 to provide an excellent seal; however in an alternate embodiment, the port interface cover 88 is removable such that the filter can be replaced when depleted. The fuel cell system manifold 400 can include an exhaust passage 406 to direct the exhaust for venting. In another alternate embodiment, a visual indicator of filter status is provided through opening 86 or a window (not shown). Many mechanical variations of the port interface cover are possible, including varying the fuel port to be in the center or on either side of the cartridge coupled side. The fuel cartridge as shown, requires no latching or locking attachments to the housing, and is coupled such that the cartridge is pushed in a fitted cavity and the port interface cover slides against a matching surface and the fuel port 83 is press-fit to a corresponding fuel port of the fuel cell system securing the fuel cartridge to the mating cavity sufficient to withstand typical handling forces and drops without releasing or impacting fuel delivery. The fuel cartridge 150 can be released by manually sliding it out of the cavity (not shown). In alternate embodiments, the mating cavity could include latching mechanisms or covers to further secure the cartridge.

The cartridge illustrated in FIGS. 8A, 8B, 8C and 8D, provides fuel delivery and fuel return functionality with respect to the associated fuel cell system ports coupled to a fuel cartridge 150. An associated fuel cell system (not shown) is comprised of a formic acid fuel cell having a cathode and anode to which a power load is connected as well known in fuel cell field. A fuel cell fuel port 402 can be coupled to the cartridge fuel port 83 such that fuel can be interchanged between the cartridge and fuel cell system. The fuel cell exhaust is a combination of liquid and vapor and gas byproducts and can be filtered by a gas-liquid separator (not shown), allowing depleted fuel to be returned through fuel line 90. The separated gas can be exhausted through port 404 coupled to sealable opening 87 in the port interface cover. As shown, exhaust port 404 is located around or optionally integrated within fuel cell fuel port 402, allowing fuel cell exhaust gas to be transferred to the port interface cover 88 of the fuel cartridge 150. It is instructive to consider pressure in three regions as shown, P1 within the housing cavity, P2 bladder fuel pressure and P3 fuel line pressure of the fuel cell fuel port coupled to the cartridge fuel port. The bladder fuel pressure is proportional to the summed pressures from elastomeric members 60 and internal cavity pressure P1. Fuel can be exchanged between the cartridge and fuel cell system by controlling the differential pressure.

Delivery of fuel from the cartridge bladder to the fuel cell stack occurs when the bladder fuel pressure P2 is greater than the fuel port pressure P3. Fuel is passively delivered from bladder to fuel cell. It is instructive to review the fuel and vapor cycle. As described previously when the liquid fuel is initially stored in the bladder the compression elements 60 provide a minimum pressure for fueling, and as pressure builds up within the housing, additional pressure contribution is added. The passive delivery of fuel represents an advance, replacing wicking systems, active suction pumps, or mechanical springs commonly employed in delivering fuel from a cartridge.

The fuel cartridge can passively operate in a fuel return mode for returning depleted or partially used formic acid fuel from the gas-liquid separator (not shown) back to the bladder, where it is mixed with original fuel. This serves two purposes, first to provide a closed system for the fuel within the confined system space, and secondly to be employed to periodically replace the utilized fuel volume suitable for increasing bladder fuel pressure P2 suitable for delivering fuel. Depleted fuel typically is partially separated and still contains both liquid and gas. If returned to a conventional non-permeable bladder, the returned gas would create a pocket and the cartridge would no longer be orientation independent. In the described cartridge, however, the depleted fuel is returned when the fuel port pressure P3 exceeds the bladder pressure P2. The formic acid fuel stored in the bladder is diluted by the returned depleted fuel, however, many return fuel cycles can be performed to maintain passive fuel pumping, before the formic acid concentration (by weight) is reduced below a usable threshold. For example, the initial fuel may start at 70% by weight formic acid, and through multiple fuel returns may be reduced to 20% by weight formic acid, at which threshold the cartridge requires refueling. Alternatively, the cartridge can optionally include a sensor (not shown) responsive to the formic acid concentration in the bladder, for example a visual indicator or chemical strip. Preferably, the associated fuel cell system (not shown) is discontinuously operable to allow for switching between delivery and return conditions, a fuel cell system for discontinuous hybrid battery charging would be appropriate. The fuel cell system (not shown) can return fuel by any suitable method that increases the separated depleted fuel pressure above the bladder fuel pressure, including the use of pumps.

The cartridge design allowing a closed fuel return within a single bladder liner is an advance over known methods, due to allowing recirculation and reuse of depleted fuel, eliminating expensive liquid fuel filters or waste containers taking up space. Additionally, the returned fuel increases the bladder volume and hence fuel pressure, with only a small penalty on concentration of formic acid, allowing passive repressurization of the bladder and control of fuel pressure through multiple fuel return operations, as concentration and fuel pressure drops in the bladder.

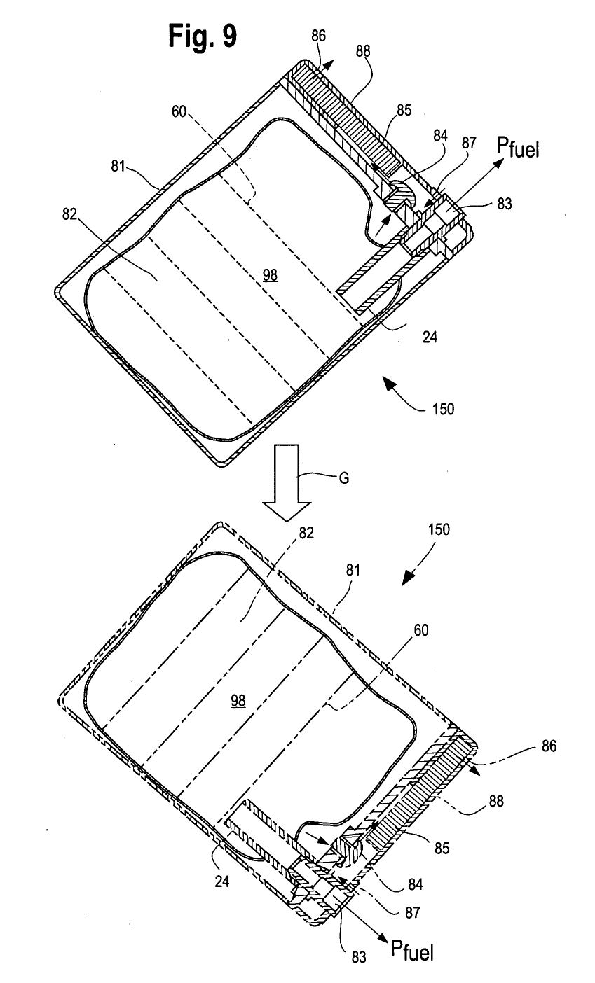

The fuel cartridge provides an orientation independent solution as shown in the storage or use orientations in FIG. 9, both in an orientation 45° from vertical and in an orientation 135° from vertical position. The bladder 82 is shown, for example, filled with formic acid 98 from refueling through the fuel port 83. The stored formic acid formulation will vary depending on the formic acid fuel cell, typically ranging from 1-90% formic acid by weight and is preferably in the range 40-70% formic acid by weight when diluted in water solution. As set forth herein, predominantly liquid fuel is contained within the bladder during storage and fueling, evaporating vapor 99, being diffused out of the bladder into the surrounding cavity. The proportion of a fully charged bladder volume to the unfilled cavity volume inside the housing 81 is preferably on the order of 90% of cavity volume, as shown. When refueling, the bladder is preferably flexible not expandable such that it is filled up to its capacity volume of less than or equal to 90% of cavity volume and no more. With increasing storage duration, the pressure in the unfilled cavity increases with time due to the diffused formic acid vapor squeezed out of the bladder 82 by the compression elements 60. The pressure increases beyond a level where it provides the primary pressure on the liquid fuel 98. When the pressure further increases above the relief valve pressure setting, the relief valve opens and formic acid vapor is exhausted through the filter and port interface cover. The relief valve pressure setting is selected above the preferred liquid fuel delivery pressure of the liquid fuel 98 through the fuel port 83 when connected to a fuel cell system. In FIG. 9A, the cartridge orientation is angled vertically, and evaporated gases inside the bladder are continuously transferred out of the bladder such that mainly liquid fuel is contained in the bladder (that is, no air pockets). A continuous feed of liquid fuel without bubbles can be delivered as bladder pressure P2 is sufficient to deliver liquid fuel out of the fuel port 83 overcoming gravity. In FIG. 9B, the cartridge is oriented angled down, and evaporated gases inside the bladder are continuously transferred out of the bladder such that mainly liquid fuel is contained in the bladder (that is, no air pockets). A continuous feed of liquid fuel without gas bubbles can be delivered horizontally to the fuel cell system. The fuel pressure will be incrementally greater in the down position by a small amount due to small weight of the fuel, but not significant variation for reliable fuel cell operation. Micro-fuel cell operation is very sensitive to fuel charge volume and pressure, and the described cartridge provides consistent and uniform volume and pressure fuel delivery. The present cartridge design allows a hazardous formic acid fuel to be stored independent of orientation while maintaining usable fuel in a liquid state, and safely venting hazardous organic vapors.

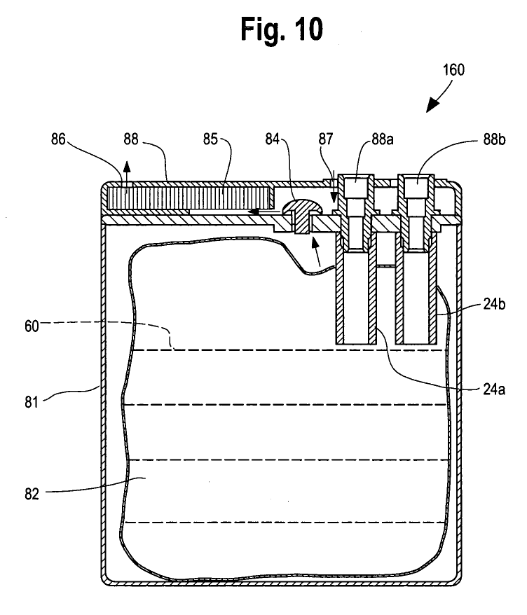

The present cartridge and system can be applied to several port configurations, depending on the end-use requirements, as shown in the embodiment of FIG. 10 with modified port interface cover 88. A two-port cartridge 160 is shown in FIG. 10, having both a fuel delivery port 83a and a separate fuel return port 83b, connecting to two fuel cell ports, fuel inlet port and fuel return port (not shown). The two cartridge ports 83a and 83b can be separately connected to bladder 82 by fuel tube 24a and 24b. Alternatively a single bladder connection can be shared through a Y-type tube (not shown). As described previously the fuel cell gas exhaust exits line 220 and can enter the port interface cover 88 through either port 83a or 83b. The advantages of these embodiments are that the fuel line does not have to be shared, as the return fuel has an independent path.

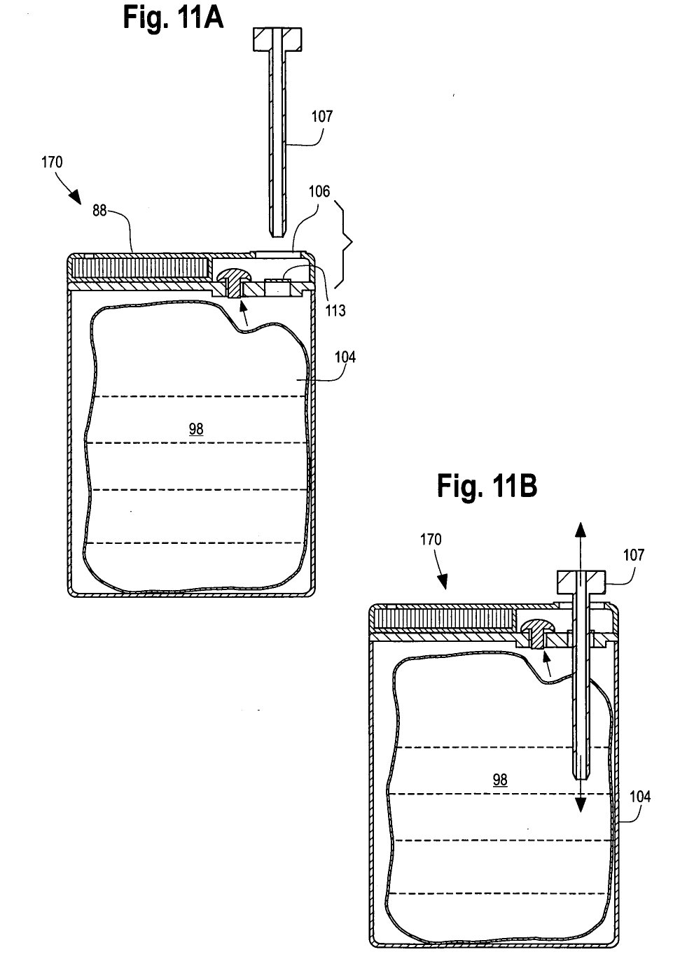

The fuel cartridges illustrated in FIGS. 7, 8A, 8B, 8C, 8D, 9 and 10 are hot-swappable, meaning that a used or empty cartridge can be disconnected and a filled or partially-used cartridge reconnected to the fuel cell system ports without fuel leakage, and can be immediately operable to deliver fuel to the fuel cell system, as the cartridge fuel port and fuel cell fuel port are sealable when not interconnected employing standard sealable valve assemblies. A simplified version of the cartridge and matching fuel cell system is shown in FIGS. 11A and 11B, which is suitable for single connection use. Bladder 104 within cartridge 170 can be a sealed bladder filled with formic acid fuel and permeable to formic acid vapor, or alternatively can be a sealed bladder with a sealable patch such that following needle insertion and removal, the hole in the sealable patch closes. Cartridge interface cover port 88 in the illustrated embodiment does not require a fuel port; in its place is a sealable layer 105, impermeable to formic acid vapor and self-resealable when punctured by a fueling nozzle or needle. The fuel cell system employs a retractable fuel port (not shown), which houses a needle 107 of suitable diameter to maintain fuel line pressure within an operating range suitable for the associated fuel cell system. Other aspects of the cartridge are as previously described. When the cartridge is coupled to the fuel cell system, thereby forming a press-fit between the cartridge interface cover 88 and the fuel cell system interface surface, the port retracts and needle 107 punctures sealable membrane 105 and sealable portion of the sealed bladder as shown in FIG. 11B, such that stored fuel can be transferred to and from the fuel cell system from the bladder supply. The gas exhaust stream of the fuel cell system can return through a couplable opening (not shown) in the interface cover port 88, as described in previous interfaces.

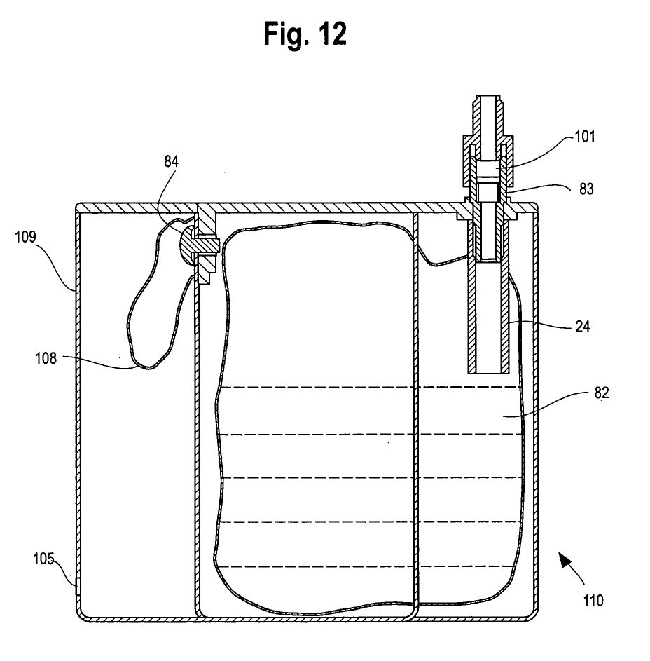

An alternate embodiment of the cartridge eliminates the exhaust filter, by internally storing exhaust, as shown in FIG. 12. This version is less preferred as it reduces effective energy density due to the extra space required, but is operable and suitable for zero-emission or low-emission end-uses. Cartridge 110 includes bladder 82, coupled to two way fuel port 83. A waste cavity housing 109 adjoins the primary housing, separated by a pressure relief valve 84 having a threshold pressure setting. An expandable exhaust pouch 108 can be coupled to the relief valve within the waste cavity, for replacement and disposal during bladder replacement, with a vent hole 105 for pouch expansion. The advantage of this design is a simplification of the cartridge interface cover port 83, to just the two way fuel valve. The fuel cell system exhaust gas is disposed of independently by the fuel cell system in this example. The fuel cell fuel port 101 is shown coupled to the cartridge fuel port 83 for illustration.

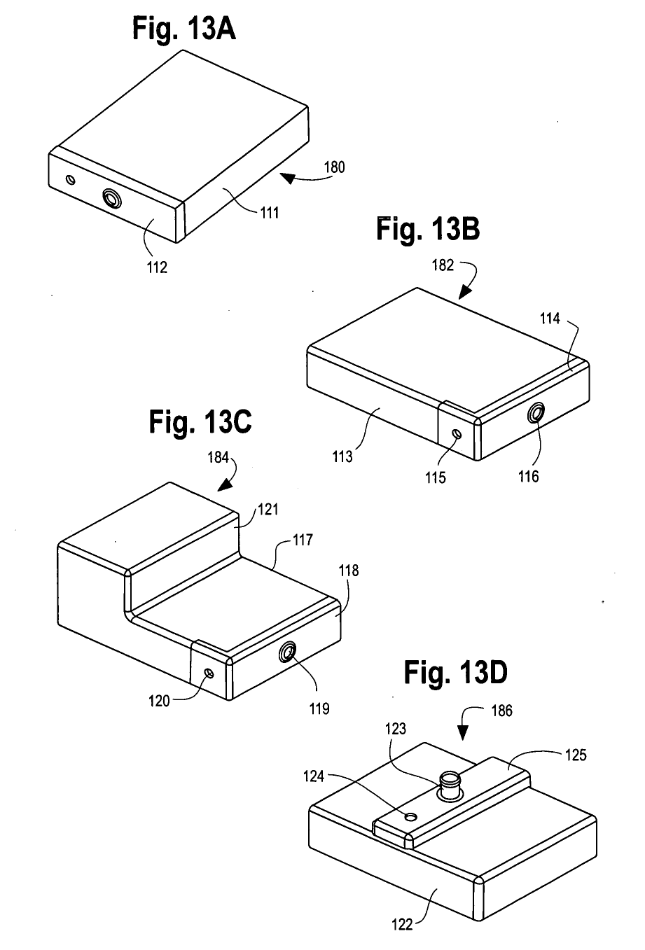

A wide range of potential configurations of the cartridge, interface and associated fuel cell system interface is possible, and some cartridge configurations are illustrated in FIGS. 13A, 13B, 13C and 13D. FIG. 13A illustrates cartridge housing 111 with ports and interface cover on a front surface of a rectangular-shaped cartridge 180. In FIG. 13B, filter exhaust portion 115 is configured on a different face from that containing fuel port 116 in cartridge 182. In FIG. 13C, cartridge 184 is configured with a securing feature or portion 121 for fitting or being latched to a cooperating securing mechanism located on the fuel cell system housing (not shown). The relative positions of interface cover 118, fuel stream port 119 and exhaust stream port 120 are shown in FIG. 13C. In some cartridge end-uses, a rectangular cartridge housing 122 may be preferred, as in the case of cartridge 186 in FIG. 13D with interface cover 125 on the largest surface.

A key requirement for fuel cell cartridges for mobile end-uses is employing available space efficiently. Due to the simplicity of the passive pump system, there is an alternate embodiment of a shape configurable cartridge (not shown), having a flexible housing (not shown), cavity and bladder, with port interface cover. The flexible housing can be semi-rigid, or formed with rigid sections separated by flexible sections to bend in a preferred manner without damaging or pinching the bladder. As the interface requires press fit to fuel cell ports to open the sealable valves, optional latches or couplings could be employed (not shown) in the case where the housing is not rigid enough to adequately maintain the press-fit.

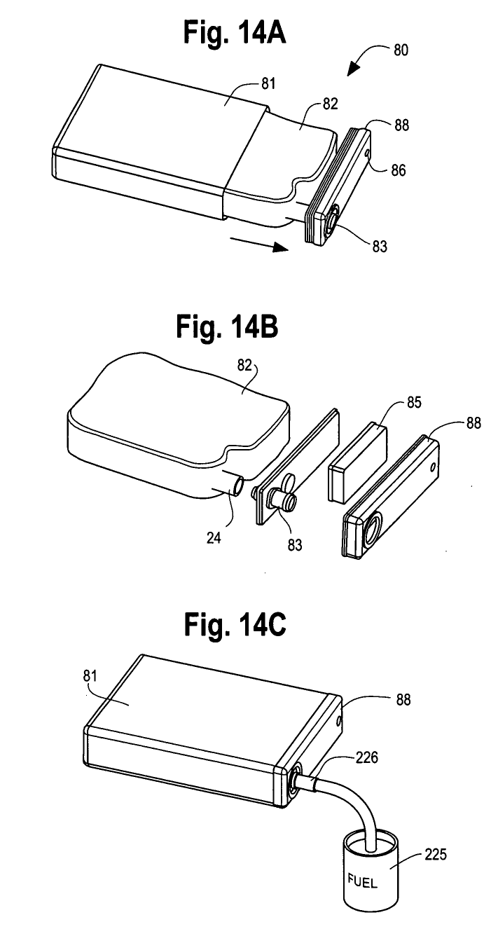

FIG. 14 illustrates a method for replacing a used bladder in the cartridge, by first removing the interface cover as shown in FIG. 14A, then discarding the used bladder and replacing it with a new bladder attached to port interface cover, as shown in FIG. 14B, and then re-inserting new bladder into the cartridge interior cavity with the interface cover attached and sealed to the cartridge housing, as depicted in FIG. 14C, and refueling the cartridge with formic acid fuel from a fuel supply 225 through a fueling port 226.

While particular elements, embodiments and applications of the present invention have been shown and described, it will be understood, of course, that the invention is not limited thereto since modifications can be made by those skilled in the art without departing from the scope of the present disclosure, particularly in light of the foregoing teachings.

What is claimed is:

1. A fuel cartridge for storing and delivering a vaporizable liquid fuel stream to an electric power generation system comprising at least one fuel cell interposed between a fuel stream inlet and a fuel stream outlet, the fuel cartridge comprising:
(a) a cartridge housing having an interior cavity and an exteriorly facing coupling surface;
(b) a fuel stream port encompassed by said coupling surface and having a sealable valve accommodating bidirectional flow of said liquid fuel stream;
(c) a pressure relief valve for discharging a gaseous stream from said cartridge housing at a set pressure;
(d) a bladder comprising a substantially liquid-impermeable and gas-permeable liner, said bladder disposed within said interior cavity and capable of storing, delivering and receiving a quantity of said liquid fuel; and
(e) a compression mechanism for imparting at least a minimal positive fluid pressure to said bladder;
whereby:
(i) in a fuel storage mode, said compression mechanism induces flow of vaporous fuel through said bladder liner, thereby increasing pressure within said cartridge interior cavity to a magnitude no greater than said set pressure;
(ii) when said fuel cell fuel stream inlet pressure is less than said bladder pressure, a liquid fuel stream is discharged from said bladder in a fuel delivery mode; and
(iii) when said fuel cell fuel stream inlet pressure is greater than said bladder pressure, said fuel cell outlet fuel stream is returned to said bladder in a fuel return mode.

2. The fuel cartridge of claim 1, further comprising:
(e) an interface cover sealingly coupled to said housing coupling surface and encasing said relief valve, said interface cover comprising:
a first opening formed therein in fluid communication with said fuel stream port,
a second opening formed therein in fluid communication with said fuel cell fuel stream outlet, and
a third opening formed therein for discharging a fuel cartridge exhaust stream.

3. The fuel cartridge of claim 2, wherein said interface cover further comprises:
a substantially fluid-impermeable seal circumscribing each of said fuel stream port and said second opening; and
a gaseous stream filter interposed between said pressure relief valve and said second opening, whereby at least one of said discharged gaseous stream and said fuel cell outlet fuel stream is passed through said filter to trap contaminants present in said at least one of said discharged gaseous stream and said fuel cell outlet fuel stream.

4. The fuel cartridge of claim 3, wherein said contaminants comprise carbon monoxide and vaporous formic acid.

5. The fuel cartridge of claim 1, wherein said compression mechanism comprises at least one spring interposed between said bladder and said cartridge housing.

6. The fuel cartridge of claim 1, wherein said compression mechanism comprises at least one fluid-filled piston.

7. The fuel cartridge of claim 1, wherein said compression mechanism comprises at least one elastomeric member.

8. The fuel cartridge of claim 7, wherein said at least one elastomeric member comprises a plurality of elastomeric members circumscribing said bladder exterior.

9. The fuel cartridge of claim 3, wherein said gaseous stream filter is configured to sealingly encase said third opening, and wherein said vaporizable liquid fuel stream is discharged through said pressure relief valve, directed through said gas filter, and exhausted through said third opening.

10. The fuel cartridge of claim 1, wherein said vaporizable liquid fuel is organic.

11. The fuel cartridge of claim 10, wherein said vaporizable liquid organic fuel comprises formic acid.

12. The fuel cartridge of claim 11, wherein said vaporizable liquid organic fuel comprises an aqueous formic acid solution having a concentration between 10-90% by weight formic acid.

13. The fuel cartridge of claim 12, wherein said aqueous formic acid solution has a concentration between 50-90% by weight formic acid.

14. The fuel cartridge of claim 13, wherein said aqueous formic acid solution has a concentration between 70-90% by weight formic acid.

15. The fuel cartridge of claim 1, wherein said bladder further comprises a pair of compression plates disposed on opposing sides of said bladder, said compression plates operatively associated with said compression mechanism for distributively imparting pressure to said bladder.

16. The fuel cartridge of claim 1, wherein said bladder filled volume is less than about 90% of said interior cavity volume.

17. The fuel cartridge of claim 17, wherein said bladder is formed from a flexible sheet material.

18. The fuel cartridge of claim 1, wherein said coupling surface encompasses said fuel stream port and said pressure relief valve.

19. The fuel cartridge of claim 1, wherein said gaseous stream filter traps contaminants in one of said discharged gaseous stream and said fuel cell outlet fuel stream, and a second gaseous stream filter traps contaminants in the other of said discharged gaseous stream and said fuel cell outlet fuel stream.

20. The fuel cartridge of claim 2, wherein said interface cover is configured such that said cartridge housing is capable of being press-fitted into a receptacle formed in said system housing such that said first opening is sealingly couplable to a corresponding first opening formed in said system housing receptacle, said corresponding first opening in fluid communication with said fuel cell fuel stream inlet, and such that said second opening is sealingly couplable to a corresponding second opening formed in said system housing receptacle, said corresponding second opening in fluid communication with said fuel cell fuel stream outlet.

21. The fuel cartridge of claim 20, wherein at least a portion of said cartridge housing is deformable such that said cartridge housing is capable of substantially filling said system housing receptacle and maintaining sufficient rigidity to establish a seal between said system housing receptacle and said interface cover.

22. The fuel cartridge of claim 2, wherein said cartridge housing and said interface cover are secured to restrict access to said bladder.

23. The fuel cartridge of claim 1, wherein said bladder is formed from a material that inhibits condensation of liquid fuel on regions of said liquid-impermeable liner not in contact with said liquid fuel.

24. The fuel cartridge of claim 1, wherein said sealable valve is a spring-loaded slidable valve capable of coupling to a cooperating valve on said system housing.

25. The fuel cartridge of claim 24, wherein said slidable valve has a bayonet-type configuration.

26. The fuel cartridge of claim 3, wherein said fuel cartridge discharged gaseous stream contaminant concentration is no greater than about 5 parts per million by weight.

27. The fuel cartridge of claim 1, wherein said bladder fluid pressure is sufficient in said fuel storage mode to permit disconnection of said cartridge from said system housing and reconnection of a fresh cartridge to said system housing without substantial deterioration of fuel cell electrical performance.

28. The fuel cartridge of claim 1, wherein said cartridge is orientation-independent, such that said fuel storage, fuel delivery and fuel return modes are operable without regard to gravity.

29. The fuel cartridge of claim 3, wherein said interface cover, said sealable valve and said pressure relief valve are configured to inhibit fuel leakage during disconnection of said cartridge from said system housing and reconnection of a fresh cartridge to said system housing.

30. The fuel cartridge of claim 2, wherein said cartridge is capable of operation in said fuel storage, fuel delivery and fuel return modes following an orientation-independent drop test from 1.5 meters.

31. The fuel cartridge of claim 2, wherein said cartridge is capable of operation in said fuel storage, fuel delivery and fuel return modes following storage at a temperature in the range of −40° C. to +70° C.

32. The fuel cartridge of claim 1, wherein said fuel stream port has a fuel feed tube extending therefrom into said bladder interior volume, whereby, in said fuel delivery mode, said fuel stream is drawn from a substantially blended fuel zone.

33. A bladder for storing and expressing a vaporizable liquid fuel stream, said bladder comprising:
(a) an inner liner permeable to said liquid fuel, said inner liner having an inwardly-facing surface defining an interior volume for containing said vaporizable liquid fuel and an outwardly-facing surface;
(b) an outer liner substantially impermeable to said liquid fuel, said outer liner having an inwardly-facing surface and an outwardly-facing surface contacting an exterior volume;
(c) a spacer interposed between said inner liner and said outer liner for maintaining a spaced relationship between said inner liner and said outer liner, thereby defining a lumen; and
(d) a passageway fluidly interconnecting said lumen and said exterior volume;
wherein said inner liner, said outer liner and said spacer form a three-layer laminate.

34. The bladder of claim 33, wherein said vaporizable liquid fuel is organic.

35. The bladder of claim 34, wherein said vaporizable liquid organic fuel comprises formic acid.

36. The bladder of claim 33, wherein at least one gas-permeable seam is formed at a junction of opposing inner liner edge portions, whereby said lumen fluidly communicates with said interior volume via said at least one gas-permeable seam to conduct vaporous fuel from said lumen to said exterior volume.

37. The bladder of claim 33, wherein said outer liner has a plurality of microperforations formed therein, whereby said lumen fluidly communicates with said interior volume via said plurality of microperforations to conduct vaporous fuel from said lumen to said exterior volume.

38. The bladder of claim 37, wherein at least one gas-permeable seam is formed at a junction of opposing inner liner edge portions, whereby said lumen fluidly communicates with said interior volume via said at least one gas-permeable seam to further conduct vaporous fuel from said lumen to said exterior volume.

39. The bladder of claim 33, wherein said inner liner comprises expanded polytetrafluoroethylene.

40. The bladder of claim 33, wherein said outer liner comprises polytetrafluoroethylene.

41. The bladder of claim 40, wherein said outer liner comprises expanded polytetrafluoroethylene.

42. The bladder of claim 41, wherein said bladder remains capable of storing and expressing said vaporizable liquid fuel stream following storage at a temperature in the range of −40° C. to +70° C.

43. The bladder of claim 41, wherein said bladder remains capable of storing and expressing said vaporizable liquid fuel stream following imposition of 100 kilograms crushing force of on all sides of said bladder.

44. The bladder of claim 41, wherein said bladder remains capable of storing and expressing said vaporizable liquid fuel stream following an orientation-independent drop test from 1.5 meters.

45. The bladder of claim 41, wherein said bladder remains capable of storing and expressing said vaporizable liquid fuel stream following vibration up to 8G.

46. The bladder of claim 41, wherein fuel condensation is inhibited at said inner liner outwardly-facing surface when said outer liner outwardly-facing surface contacts an exterior volume having a temperature lower than said lumen temperature.

47. The bladder of claim 33, wherein said spacer is formed as a mesh.

48. The bladder of claim 33, wherein said spacer comprises a plurality of discrete spacer elements.

49. The bladder of claim 48, wherein said spacer elements are arranged in a grid.

50. The bladder of claim 48, wherein said spacer elements are arranged randomly.

51. The bladder of claim 33, wherein said laminate is consolidated by hot-press bonding.

52. The bladder of claim 33, wherein said inner liner and said outer liner are formed from a flexible sheet material.

53. A bladder for storing and expressing a vaporizable liquid fuel stream, said bladder comprising:
(a) an inner liner permeable to said liquid fuel, said inner liner having an inwardly-facing surface defining an interior volume for containing said vaporizable liquid fuel and an outwardly-facing surface;
(b) an outer liner substantially impermeable to said liquid fuel, said outer liner having an inwardly-facing surface and an outwardly-facing surface contacting an exterior volume; and
(c) a passageway fluidly interconnecting said lumen and said exterior volume;
wherein at least one of said inner liner and said outer liner has at least one spacer extending therefrom in the direction of the other of said inner layer and said outer layer, thereby defining a lumen, and wherein said inner liner and said outer liner form a two-layer laminate.

54. The bladder of claim 53, wherein said vaporizable liquid fuel is organic.

55. The bladder of claim 54, wherein said vaporizable liquid organic fuel comprises formic acid.

56. The bladder of claim 53, wherein at least one gas-permeable seam is formed at a junction of opposing inner liner edge portions, whereby said lumen fluidly communicates with said interior volume via said at least one gas-permeable seam to conduct vaporous fuel from said lumen to said exterior volume.

57. The bladder of claim 53, wherein said outer liner has a plurality of microperforations formed therein, whereby said lumen fluidly communicates with said interior volume via said plurality of microperforations to conduct vaporous fuel from said lumen to said exterior volume.

58. The bladder of claim 53, wherein at least one gas-permeable seam is formed at a junction of opposing inner liner edge portions, whereby said lumen fluidly communicates with said interior volume via said at least one gas-permeable seam to further conduct vaporous fuel from said lumen to said exterior volume.

59. The bladder of claim 53, wherein said inner liner comprises expanded polytetrafluoroethylene.

60. The bladder of claim 53, wherein said outer liner comprises polytetrafluoroethylene.

61. The bladder of claim 60, wherein said inner liner comprises expanded polytetrafluoroethylene.

62. The bladder of claim 61, wherein said bladder remains capable of storing and expressing said vaporizable liquid fuel stream following storage at a temperature in the range of −40° C. to +70° C.

63. The bladder of claim 61, wherein said bladder remains capable of storing and expressing said vaporizable liquid fuel stream following imposition of 100 kilograms crushing force of on all sides of said bladder.

64. The bladder of claim 61, wherein said bladder remains capable of storing and expressing said vaporizable liquid fuel stream following an orientation-independent drop test from 1.5 meters.

65. The bladder of claim 61, wherein said bladder remains capable of storing and expressing said vaporizable liquid fuel stream following vibration up to 8G.

66. The bladder of claim 61, wherein fuel condensation is inhibited at said inner liner outwardly-facing surface when said outer liner outwardly-facing surface contacts an exterior volume having a temperature lower than said lumen temperature.

67. The bladder of claim 53, wherein said at least one spacer is formed as a mesh.

68. The bladder of claim 53, wherein said at least one spacer comprises a plurality of discrete spacer elements.

69. The bladder of claim 68, wherein said at least one spacer is arranged in a grid.

70. The bladder of claim 68, wherein said at least one spacer is arranged randomly.

71. The bladder of claim 53, wherein said laminate is consolidated by hot-press bonding.

72. The bladder of claim 53, wherein said inner liner and said outer liner are formed from a flexible sheet material.
